(19) United States
(12) Patent Application Publication
(10) Pub. No.: US 2006/0291555 A1
(43) Pub. Date: Dec. 28, 2006

(54) MPEG-2 to MPEG-4 convertor

(75) Inventor: Shih-Fong Tseng, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/245,534

(22) Filed: Oct. 7, 2005

(30) Foreign Application Priority Data
Jun. 22, 2005 (TW) 94120749

(51) Int. Cl. H04N 11/04; H04N 11/02; H04N 7/12; H04B 1/66

(52) U.S. Cl. 375/240.01

(57) ABSTRACT

A device converting MPEG-2 format data to MPEG-4 format data at high speeds comprises a processor controlling data input and output of the electronic device, and extracting MPEG-2 format data from input data. The electronic device comprises an MPEG-2 decoder receiving the MPEG-2 format data extracted by the processor and converting the MPEG-2 format data to video and audio signals, and an MPEG-4 encoder receiving the video and audio signals, and converting the video and audio signals to MPEG-4 format data.

### BACKGROUND

The invention relates to data format conversion, and more particularly, to devices converting MPEG-2 format data to MPEG-4 format data at high speeds.

Conventional MPEG-2 to MPEG-4 conversion, utilizing a software program, occupies significant CPU bandwidth and time. For example, using an application such as “DVDx” on a computer with Athelon-2000+ CPU to convert a 2 hour and 5 minute file in MPEG-2 format can take up to 5 hours, occupying 90% CPU bandwidth and up to 9 hours in a computer system with Duron-1G CPU. The computer system is almost not capable for any other tasks within the long processing period.

### SUMMARY

A device converting MPEG-2 format data to MPEG-4 format data at high speeds is disclosed. The device comprises a processor controlling data input and output and extracting MPEG-2 format data from input data. The device comprises an MPEG-2 decoder receiving the MPEG-2 format data extracted by the processor and converting the MPEG-2 format data to video and audio signals, and an MPEG-4 encoder receiving and converting the video and audio signals to MPEG-4 format data.

### DESCRIPTION OF THE DRAWINGS

The accompanying drawings, incorporated in and constitute a part of this specification, illustrate embodiments of the invention and, together with the description, serve to explain the features, advantages, and principles of the invention.

FIG. 1 is a block diagram of an electronic device according to an embodiment of the invention.

### DETAILED DESCRIPTION

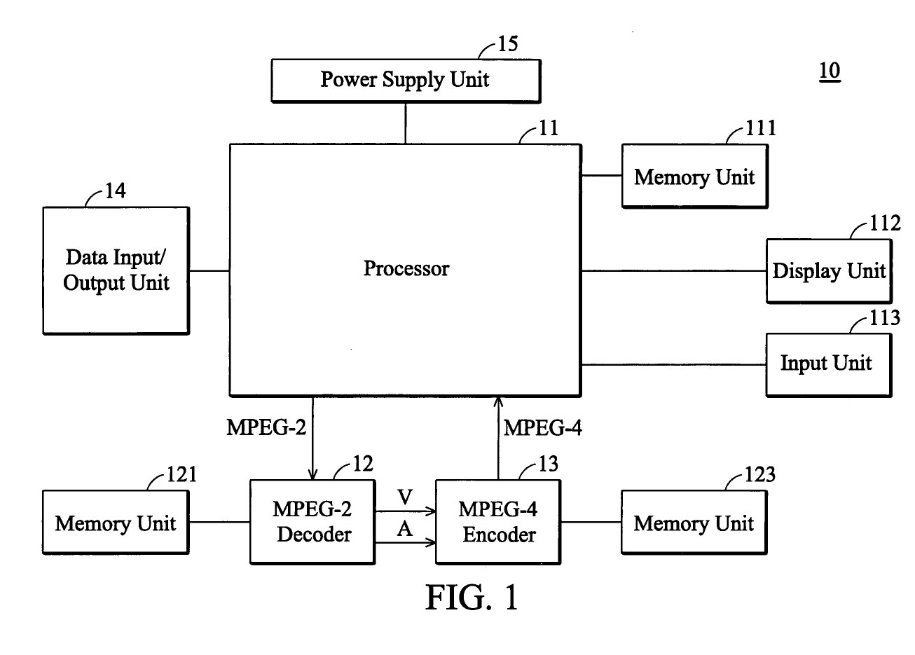

FIG. 1 is a block diagram of an electronic device 10 according to an embodiment of the invention. Electronic device 10 comprises a processor 11, an MPEG-2 decoder 12 and an MPEG-4 encoder 13.

Processor 11 controls the data input and output and further verifies input data to prevent data corruption. When the input data is in MPEG-2 format, processor 11 directs the MPEG-2 format data to the MPEG-2 decoder 12. Processor 11 is further coupled to a memory unit 111 retaining temporary data for high speed computing. MPEG-2 decoder 12 is further coupled to a memory unit 121 retaining temporary data for high speed computing.

MPEG-2 format data is received by MPEG-2 decoder 12 and converted therein to video signal V and audio signal A. Because video and audio decoding are independent in MPEG-2 standard, MPEG-2 decoder 12 employs separate video and audio decoding mechanisms. MPEG-2's real-time-playback format capability allows MPEG-2 decoder 12 to convert the MPEG-2 format data into video signal V and audio signal A in realtime. Video signal V and audio signal A are received by MPEG-4 encoder 13 and converted therein to MPEG-4 format data. MPEG-4 coder 13 processes the data in video signal V and audio signal A, and performs realtime encoding. MPEG-4 encoder 13 is further coupled to a memory unit 123 retaining temporary data for high speed computing.

Processor 11 is further coupled to a data input/output unit 14 receiving and/or outputting multimedia data. Data input/output unit 14 can be a USB master controller connecting to USB slave devices such as HDD or CD-ROM. Data input/output unit 14 can also be a USB slave controller connecting to a USB master device such as a computer system. Data input/output unit 14 can further be an Ethernet (LAN) controller, a wireless LAN controller, an IEEE-1394 controller or a flash memory card reader, connecting to various external data sources or data storage devices.

Processor 11 is further coupled to a display unit 112 displaying status or user control interface of the system. Processor 11 is further coupled to at least one input unit 113 for user control interface.

Electronic device 10 further comprises a power supply unit 15 providing power to the device. Power supply unit 15 can be a battery. Power supply unit 15 can connect to an external power source via a power connector (not shown). Power supply unit 15 can further comprise a rechargeable battery. The power supply unit 15 uses the rechargeable battery as a power source when the connector is not connected to the external power source, and uses the external power source as a power source and charges the rechargeable battery when the connector is connected to the external power source.

Electronic device 20 can be connected to various multimedia storage/processing/transmitting systems, receiving MPEG-2 format data and outputting MPEG-4 format data in realtime via constituent input/output interfaces. Multimedia storage/processing/transmitting systems receive converted MPEG-4 format data at high speeds without system bandwidth consumption.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. An device for MPEG-2 to MPEG-4 conversion comprising:
a processor controlling data input and output of the electronic device, and extracting MPEG-2 format data from input data;
an MPEG-2 decoder receiving the MPEG-2 format data extracted by the processor, and converting the MPEG-2 format data to video and audio signals; and
an MPEG-4 encoder receiving the video and audio signals and converting the video and audio signals to MPEG-4 format data.

2. The device as claimed in claim 1, further comprising a data input/output unit coupled to the processor.

3. The device as claimed in claim 2, wherein the data input/output unit is a USB master controller.

4. The device as claimed in claim 2, wherein the data input/output unit is a USB slave controller.

5. The device as claimed in claim 2, wherein the data input/output unit is an Ethernet (LAN) controller.

6. The device as claimed in claim 2, wherein the data input/output unit is a wireless LAN controller.

7. The device as claimed in claim 2, wherein the data input/output unit is an IEEE-1394 controller.

8. The device as claimed in claim 2, wherein the data input/output unit is a flash memory card reader.

9. The device as claimed in claim 1, further comprising at least one input unit for user control interface.

10. The device as claimed in claim 1, further comprising a display unit displaying status or user control interface of the system.

11. The electronic device as claimed in claim 1, further comprising a memory unit coupled to the processor.

12. The device as claimed in claim 1, further comprising a memory unit coupled to the MPEG-2 decoder.

13. The device as claimed in claim 1, further comprising a memory unit coupled to the MPEG-4 encoder.

14. The device as claimed in claim 1, further comprising a power supply unit providing power to the electronic device.

15. The device as claimed in claim 14, further comprising a power connector coupled to the power supply unit for connection to an external power source.

16. The device as claimed in claim 15, further comprising a rechargeable battery, wherein the power supply unit uses the rechargeable battery as a power source when the connector is not connected to the external power source, and uses the external power source as a power source and charges the rechargeable battery when the connector is connected to the external power source.

17. The device as claimed in claim 14, wherein the power supply unit is a battery.
